(19) United States
(12) Patent Application Publication
(10) Pub. No.: US 2008/0129829 A1
(43) Pub. Date: Jun. 5, 2008

(54) SIGHT STABILIZATION APPARATUS FOR MOBILE ROBOT

(76) Inventors: Ho Chul SHIN, Daejeon (KR); Dae Hwan HWANG, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/873,064

(22) Filed: Oct. 16, 2007

(30) Foreign Application Priority Data
Oct. 31, 2006 (KR) 10-2006-0106786

(51) Int. Cl. H04N 5/228

(52) U.S. Cl. 348/208.1

(57) ABSTRACT

Provided is a sight stabilization apparatus for a mobile robot having a camera. The sight stabilization apparatus includes a camera vibration detector, a moving pattern analyzer, a sight controller, and a camera sight adjustor. The camera vibration detector detects vibration of the camera when the mobile robot moves. The moving pattern analyzer analyzes a moving pattern of the mobile robot based on a type, a moving method, and a moving speed of the mobile robot. The sight controller calculates a vibration compensation value based on the analyzed moving pattern of the mobile robot for compensating for the vibration of the camera. The sight adjustor adjusts a sight direction of the camera according to the vibration compensation value calculated by the sight controller.

### CROSS-REFERENCE TO RELATED APPLICATIONS

This application claims the priority of Korean Patent Application No. 10-2006-0106786, filed on Oct. 31, 2006, in the Korean Intellectual Property Office, the disclosure of which is incorporated herein by reference.

### BACKGROUND OF THE INVENTION

1. Field of the Invention

The present invention relates to a sight stabilization apparatus that can stably maintain the sight direction of a camera of a mobile robot in a desired direction by analyzing and controlling vibrations of the mobile robot when the mobile robot moves.

This work was supported by the IT R&D program of MIC/IITA[2005-S-033-02, Embedded Component Technology and Standardization for URC]

2. Description of the Related Art

In general, unlike robot arms, mobile robots can move to a desired place using their wheels or legs. Such mobile robots can be used for taking pictures or monitoring a remote place by attaching a camera. The mobile robots can be used in various forms and manners for various industrial fields.

A camera of a mobile robot functions as eyes of a human. That is, the mobile robot operates based on information extracted from images captured by the camera.

Mobile robots can be classified according to the moving mechanism. For example, a robot having three or more wheels can stably move on an even surface, and a robot having multiple legs can walk like a human. An inverted pendulum robot can move using one or two wheels.

When a mobile robot moves using rotational and translational motions, the mobile robot may wobble. In this case, a camera attached to the mobile robot may also wobble, and thus the sight direction of the camera may be shaken. Therefore, it is difficult to take desired images using the camera when the mobile robot moves, and thus image processing or remote monitoring cannot be properly performed using the mobile robot.

In this regard, an anti-shake device is disclosed in Korean Patent No. 10-0254910. The disclosed anti-shake device is used to compensate for vibrations of a video camera caused by, for example, movements of operator's hands.

For minimizing the effects of vibrations of a camera, the disclosed anti-shake device controls an optical path changer using a controller according to vibrations of incident light caused by the vibrations of the camera.

However, the disclosed anti-shake device, which is provided for a video camera, compensates for vibrations of a camera by partially moving a lens of the camera. Therefore, the disclosed anti-shake device is not suitable for a mobile robot having a vibration pattern different from that of the video camera.

Thus, other technology than the disclosed technology is needed for reducing vibrations of a camera of a mobile robot when the mobile robot moves.

### SUMMARY OF THE INVENTION

An aspect of the present invention provides a sight stabilization apparatus that can detect and control vibrations of a camera of a robot by analyzing moving patterns of the robot for stably maintaining the sight of the camera.

An aspect of the present invention also provides a sight stabilization apparatus that can detect and control vibrations of a camera of a robot by analyzing images taken by the camera for stably maintaining the sight of the camera.

According to an aspect of the present invention, there is provided a sight stabilization apparatus for a mobile robot with a camera, the sight stabilization apparatus including: a camera vibration detector detecting vibration of the camera when the mobile robot moves; a moving pattern analyzer analyzing a moving pattern of the mobile robot based on a type, a moving method, and a moving speed of the mobile robot; a sight controller calculating a vibration compensation value based on the analyzed moving pattern of the mobile robot for compensating for the vibration of the camera; and a sight adjustor adjusting a sight direction of the camera according to the vibration compensation value calculated by the sight controller.

According to another aspect of the present invention, there is provided a sight stabilization apparatus for a mobile robot with a camera, the sight stabilization apparatus including: an image analyzer analyzing images captured by the camera for detecting a variation of a sight direction of the camera; a moving pattern analyzer analyzing a moving pattern of the mobile robot based on a type, a moving method, and a moving speed of the mobile robot; a sight controller calculating a vibration compensation value based on the analyzed moving pattern of the mobile robot for compensating for the variation of the sight direction of the camera; and a sight adjustor adjusting the sight direction of the camera according to the vibration compensation value calculated by the sight controller.

According to another aspect of the present invention, there is provided a mobile robot with a camera, the mobile robot including: a camera vibration detector detecting vibration of the camera when the mobile robot moves; a moving pattern analyzer analyzing a moving pattern of the mobile robot based on a type, a moving method, and a moving speed of the mobile robot; a sight controller calculating a vibration compensation value based on the analyzed moving pattern of the mobile robot for compensating for the vibration of the camera; and a sight adjustor adjusting a sight direction of the camera according to the vibration compensation value calculated by the sight controller.

According to another aspect of the present invention, there is provided a mobile robot with a camera, the mobile robot including: an image analyzer analyzing images captured by the camera for detecting a variation of a sight direction of the camera; a moving pattern analyzer analyzing a moving pattern of the mobile robot based on a type, a moving method, and a moving speed of the mobile robot; a sight controller calculating a vibration compensation value based on the analyzed moving pattern of the mobile robot for compensating for the variation of the sight direction of the camera; and a sight adjustor adjusting the sight direction of the camera according to the vibration compensation value calculated by the sight controller.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram schematically illustrating a sight stabilization apparatus for a mobile robot according to a first embodiment of the present invention;

FIG. 2 is a block diagram schematically illustrating a sight stabilization apparatus for a mobile robot according to a second embodiment of the present invention;

FIGS. 3A through 3C are detailed views for illustrating examples of a sight adjustor of a sight stabilization apparatus for a mobile robot according to the present invention;

FIG. 4 is a view illustrating an inverted pendulum robot including a sight stabilization apparatus according to the present invention;

FIG. 5 is a view illustrating a multiple-legged robot including a sight stabilization apparatus according to the present invention; and

FIG. 6 is a view illustrating a rough road moving robot including a sight stabilization apparatus according to the present invention.

### DETAILED DESCRIPTION OF THE PREFERRED EMBODIMENT

Exemplary embodiments of the present invention will now be described in detail with reference to the accompanying drawings. In every possible case, like reference numerals are used for referring to the same or similar elements in the description and drawings. In the following description, well-known functions or constructions are not described in detail since they would obscure the invention in unnecessary detail.

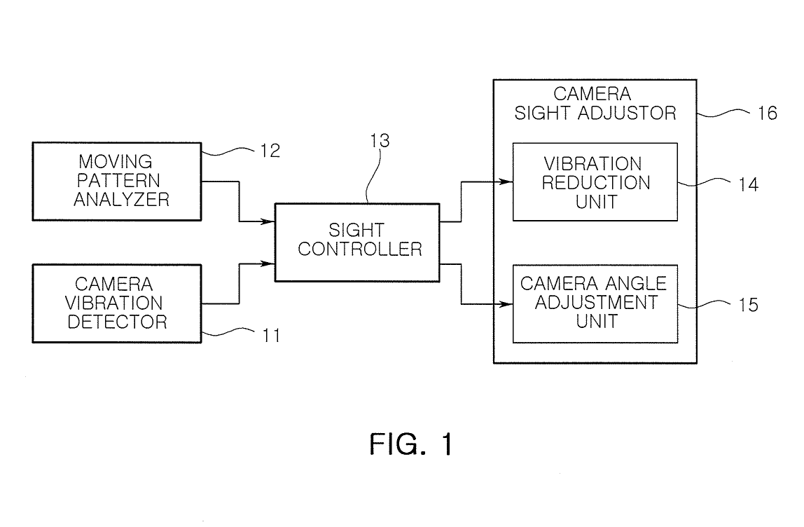

FIG. 1 is a function block diagram schematically illustrating a sight stabilization apparatus for a mobile robot according to a first embodiment of the present invention.

Referring to FIG. 1, the sight stabilization apparatus for a mobile robot includes a camera vibration detector 11, a moving pattern analyzer 12, a sight controller 13, and a camera sight adjustor 16.

The camera vibration detector 11 detects vibrations of a camera of the mobile robot when the mobile robot moves.

The moving pattern analyzer 12 analyzes moving patterns of the mobile robot based on the type, moving method, and moving speed of the mobile robot.

The sight controller 13 calculates vibration compensation values based on the analyzed moving patterns of the mobile robot for compensating for the vibrations of the camera.

The camera sight adjustor 16 adjusts the sight direction of the camera according to the vibration compensation values calculated by the sight controller 13.

Here, the camera vibration detector 11 may include a vibration detection sensor such as a gyro sensor or an acceleration sensor that is attached to the camera for detecting vibrations of the camera when the mobile robot moves.

As explained above, the moving pattern analyzer 12 is used to analyze the moving patterns of the mobile robot based on the type, moving method, and moving speed of the mobile robot.

Here, the type of the mobile robot means a type classified by the moving mechanism of the mobile robot, and the moving method of the mobile robot means a particular moving manner of the mobile robot. The moving speed of the mobile robot means a speed related to the moving pattern of the mobile robot.

Therefore, the moving pattern of the mobile robot can be characterized by a combination of the type, moving method, and moving speed of the mobile robot.

The moving pattern analyzer 12 receives above-described information about the moving of the robot from a robot move controller (not shown) and analyzes moving patterns of the robot using the received information.

When the mobile robot moves, the sight controller 13 receives information about moving patterns of the mobile robot and movements of the camera from the camera vibration detector 11 and the moving pattern analyzer 12 in order to calculate vibration compensation values for the camera.

The above-described sight stabilization apparatus of the first embodiment shown in FIG. 1 may operate as follows.

When the mobile robot moves, the sight stabilization apparatus detects vibrations of the camera of the mobile robot and analyzes the type, moving method, moving speed of the mobile robot.

Next, the sight stabilization apparatus calculates vibration compensation values using a predetermined algorism based on the analyzed results for compensating for the vibrations of the camera.

Then, the sight stabilization apparatus adjusts the sight direction of the camera according to the calculated vibration compensation values.

In this way, the sight stabilization apparatus can be usefully used for stabilizing the sight of a camera of a mobile robot according to the type of the mobile robot.

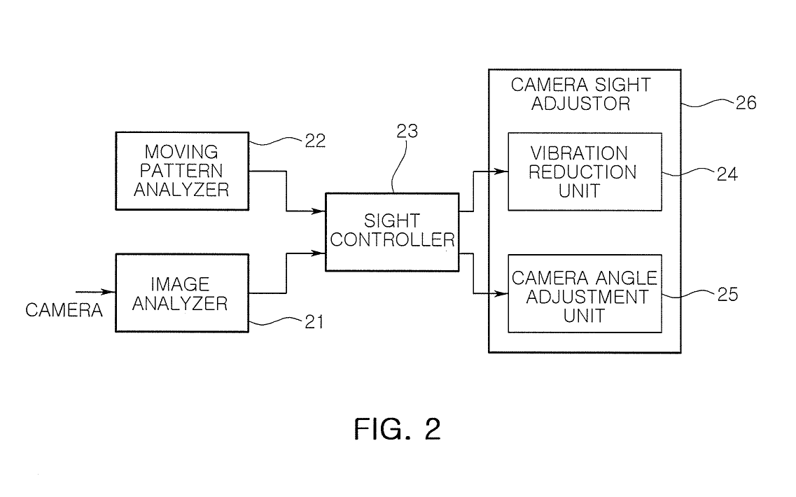

FIG. 2 is a block diagram schematically illustrating a sight stabilization apparatus for a mobile robot according to a second embodiment of the present invention.

Referring to FIG. 2, the sight stabilization apparatus of second embodiment includes an image analyzer 21, a moving pattern analyzer 22, a sight controller 23, and a camera sight adjustor 26.

The image analyzer 21 analyzes images captured by a camera of the mobile robot for detecting variations of the sight direction of the camera.

The moving pattern analyzer 22 analyzes moving patterns of the mobile robot based on the type, moving method, and moving speed of the mobile robot.

The sight controller 23 compares the variations of the sight direction of the camera analyzed by the image analyzer 21 with the moving pattern of the mobile robot analyzed by the moving pattern analyzer 22 in order to calculate vibration compensation values for compensating for the variations of the sight direction of the camera.

The camera sight adjustor 26 adjusts the sight direction of the camera according to the vibration compensation values calculated by the sight controller 23.

Here, the image analyzer 21 detects a variation of the sight direction of the camera by comparing a currently captured image with the previous image and calculating a movement of a reference point. Here, an arbitrary object of an image captured by the camera can be selected as the reference point.

When the mobile robot moves, the sight controller 23 receives information about moving patterns of the mobile robot and movements of the camera of the mobile robot from the image analyzer 21 and the moving pattern analyzer 22 in order to calculate vibration compensation values for the camera using a predetermined algorism.

Here, the predetermined algorism may be a well-known compensation algorism used for extracting a difference using input data.

The above-described sight stabilization apparatus of the second embodiment shown in FIG. 2 may operate as follows.

When the mobile robot moves, the sight stabilization apparatus analyzes images captured by the camera of the mobile robot to detect vibration patterns of the sight direction of the camera.

Next, the sight stabilization apparatus calculates vibration compensation values using a predetermined algorism for compensating for detected vibrations of the camera.

Then, the sight stabilization apparatus adjusts the sight direction of the camera according to the calculated vibration compensation values.

In this way, the sight stabilization apparatus can be usefully used for stabilizing the sight of a camera of a mobile robot according to the type of the mobile robot.

In the sight stabilization apparatuses of FIGS. 1 and 2, the camera sight adjustors 16 and 26 include camera angle adjustment units 15 and 25, respectively. The camera angle adjustment units 15 and 25 are used for rotating a camera by a predetermined angle according to the vibration compensation values calculated by the sight controllers 13 and 23.

The camera sight adjustors 16 and 26 further include vibration reduction units 14 and 24, respectively. Each of the vibration reduction units 14 and 24 includes a damper and a spring for reducing vibration of a camera.

The damper and spring of vibration reduction unit 14 and 24 can be embodied as an active type or a passive type, respectively. In the active type case, the damper and spring are controlled according to the vibration compensation values of the sight controller 13 and 23.

Each of the camera sight adjustor 16 and 26 can include one or both of at least one vibration reduction unit 14 and 24 and a camera angle adjustment unit 15 and 25 according to the vibration characteristics of a mobile robot.

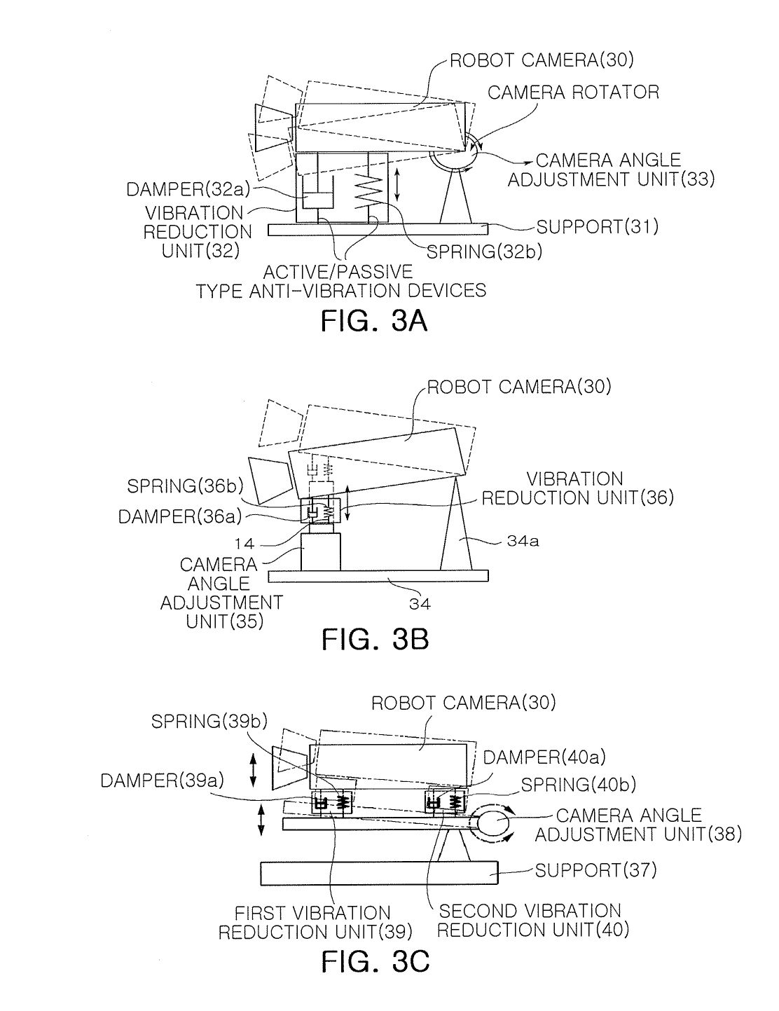

FIGS. 3A through 3C are views for illustrating examples of the camera sight adjustors 16 and 26.

Referring to FIG. 3A, a vibration reduction unit 32 is disposed at a front side of a camera 30 of a robot for reducing vibration of the camera 30 when the robot moves, and a camera angle adjustment unit 33 is disposed at a rear side of the camera 30 for adjusting the sight direction of the camera 30 by controlling the angle and position of the camera 30.

Therefore, the sight direction of the camera 30 can be adjusted using the camera angle adjustment unit 33 while absorbing vibrations of the camera 30 using a damper 32a and a spring 32b of the vibration reduction unit 32 so that the sight of the camera 30 can be stabilized.

Referring to FIG. 3B, a pivot 34a is disposed at a rear side of a camera 30 for rotating the camera 30 upward and downward, and a camera angle adjustment unit 35 is disposed at a front side of the camera 30. The camera angle adjustment unit 35 has a cylindrical shape and vertically extendable. Here, the camera angle adjustment unit 35 is connected to the camera 30 through a vibration reduction unit 36 including an active/passive type damper 36a and a spring 36b. Therefore, the sight direction of the camera 30 can be adjusted by rotating the camera 30 upward or downward using the vertically extendable camera angle adjustment unit 35, and vibrations of the camera 30 can be reduced by the vibration reduction unit 36. Hence, the sight of the camera 30 can be stabilized.

Referring to FIG. 3C, a camera angle adjustment unit 38 is fixed to a support 37 and is rotatable upward and downward. The camera angle adjustment unit 38 is connected to a camera 30 through first and second vibration reduction units 39 and 40 that are disposed between the camera 30 and an arm of the camera angle adjustment unit 38. The first and second vibration reduction units 39 and 40 are disposed at front and rear sides of the camera 30, respectively. The first vibration reduction unit 39 includes an active/passive type damper 39a and/or a spring 39b, and the second vibration reduction unit 40 includes an active/passive type damper 40a and/or a spring 40b. The camera angle adjustment unit 38 adjusts the sight direction of the camera 30, and the first and second vibration reduction unit 39 and 40 absorb and balance vibrations of the camera 30.

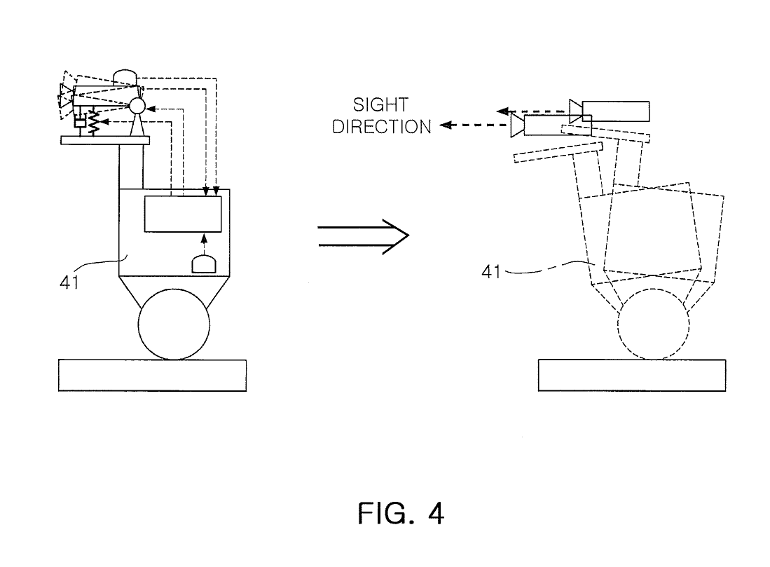

Applications of the sight stabilization apparatus will now be described with reference to FIGS. 4, 5, and 6 according to the types of robots.

FIG. 4 is a view illustrating an inverted pendulum robot 41 including a sight stabilization apparatus according to the present invention.

In general, the inverted pendulum robot 41 includes two or fewer wheels as a moving mechanism.

The sight direction of a camera varies as shown in FIG. 4 when the inverted pendulum robot 41 moves in its own manner.

Since the inverted pendulum robot 41 moves using two or less wheels, the position of the inverted pendulum robot 41 is properly controlled while the inverted pendulum robot 41 moves, in order to prevent the inverted pendulum robot 41 from falling forward or backward. Thus, the camera is rotated upward or downward according to the position controlling for the inverted pendulum robot 41.

In this case, the sight stabilization apparatus analyzes moving patterns of the inverted pendulum robot 41 based on the moving speed of the inverted pendulum robot 41 in order to adjust the sight direction of the camera and absorb vibrations of the camera. Therefore, the sight direction of the camera can be constantly kept regardless of the position of the inverted pendulum robot 41.

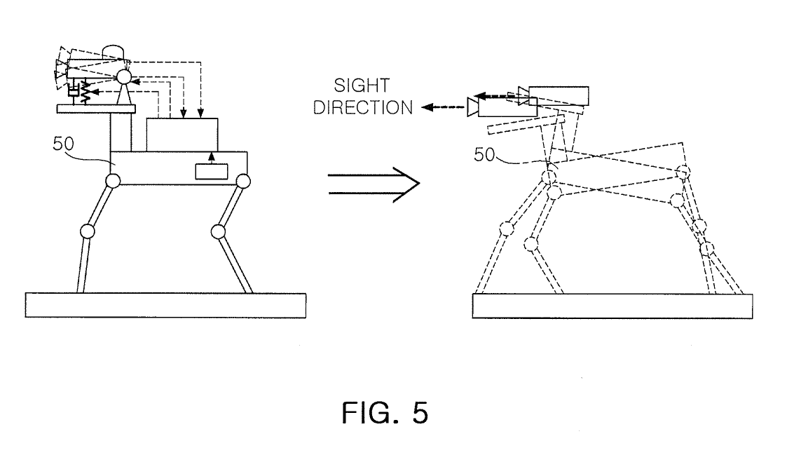

FIG. 5 is a view illustrating a multiple-legged robot 50 including a sight stabilization apparatus according to the present invention.

The multiple-legged robot 50 includes at least two legs for moving by alternately moving the legs.

For example, the legs of the multiple-legged robot 50 move as shown in FIG. 5. Since the multiple-legged robot 50 moves using the at least two legs, a camera vibrates in different ways according to the movements of the respective legs.

In this case, the sight stabilization apparatus analyzes moving patterns of the multiple-legged robot 50 based on the method of moving the legs and the moving speed of the multiple-legged robot 50 and detects vibrations of the camera, in order to keep the sight direction of the camera constant by rotating the camera upward when the sight direction of the camera falls down and rotating the camera downward when the sight direction of the camera rises

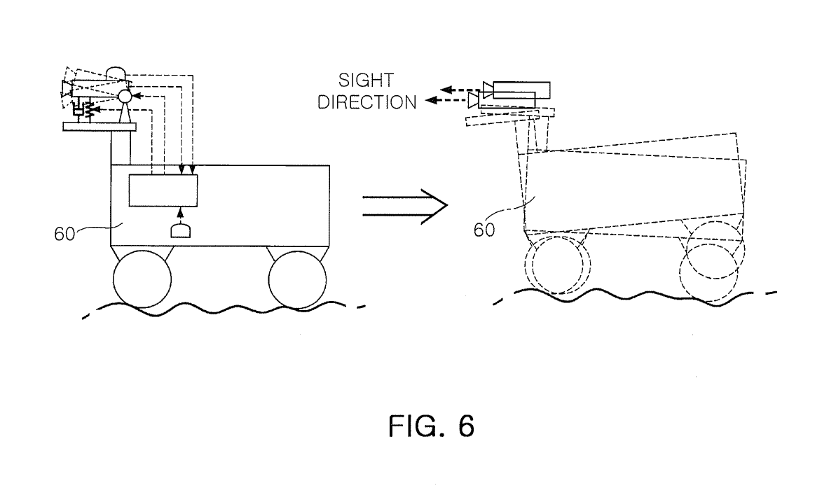

FIG. 6 is a view illustrating a rough road moving robot 60 including a sight stabilization apparatus according to the present invention.

The rough road moving robot 60 includes three or more wheels and is capable of moving on a rough road as well as a paved road.

The sight direction of a camera varies as shown in FIG. 6 when the rough road moving robot 60 moves in its own manner.

The rough road moving robot 60 does not largely wobble when it moves on a smooth road. However, when the rough road moving robot 60 moves on a rough road, the rough road moving robot 60 wobbles in proportion to the degree of road unevenness. The wobbling of the rough road moving robot 60 is also affected by the moving speed of the rough road moving robot 60.

In this case, the sight stabilization apparatus analyzes moving patterns of the rough road moving robot 60 based on the moving speed of the rough road moving robot 60 and measures vibration of a camera of the rough road moving robot 60 in order to adjust the sight direction of the camera.

The sight stabilization apparatus included in each of the inverted pendulum robot 41, the multiple-legged robot 50, and the rough road moving robot 60 may have the same elements as that shown in FIG. 1.

That is, the sight stabilization apparatus includes: a camera vibration detector 11 that detects vibrations of a camera of a mobile robot when the mobile robot moves; a moving pattern analyzer 12 that analyzes moving patterns of the mobile robot based on the type, moving method, and moving speed of the mobile robot; a sight controller 13 that calculates vibration compensation values based on the analyzed moving patterns of the mobile robot for compensating for the vibrations of the camera; and a camera sight adjustor 16 that adjusts the sight direction of the camera according to the vibration compensation values calculated by the sight controller 13.

Alternatively, the sight stabilization apparatus included in each of the inverted pendulum robot 41, the multiple-legged robot 50, and the rough road moving robot 60 may have the same elements as that shown in FIG. 2.

That is, the sight stabilization apparatus includes: an image analyzer 21 that analyzes images captured by a camera of the mobile robot for detecting variations of the sight direction of the camera; a moving pattern analyzer 22 that analyzes moving patterns of the mobile robot based on the type, moving method, and moving speed of the mobile robot; a sight controller 23 that compares the variations of the sight direction of the camera analyzed by the image analyzer 21 with the moving pattern of the mobile robot analyzed by the moving pattern analyzer 22 in order to calculate vibration compensation values for compensating for movements of the camera; and a camera sight adjustor 26 that adjusts the sight direction of the camera according to the vibration compensation values calculated by the sight controller 23.

As described above, the sight stabilization apparatus of the present invention is used for a mobile robot. The sight stabilization apparatus analyzes vibration of a camera of the mobile robot or images captured by the camera to detect variations in the sight direction of the camera caused by wobbling of the mobile robot. Then, the sight stabilization apparatus calculates compensation values for the variations of the sight direction of the camera and controls the sight direction of the camera using the compensation values so that the sight direction of the camera can be stably controlled.

While the present invention has been shown and described in connection with the exemplary embodiments, it will be apparent to those skilled in the art that modifications and variations can be made without departing from the spirit and scope of the invention.

Therefore, the scope of the invention is defined not by the detailed description of the invention but by the appended claims.

What is claimed is:

1. A sight stabilization apparatus for a mobile robot with a camera, the sight stabilization apparatus comprising:
a camera vibration detector detecting vibration of the camera when the mobile robot moves;
a moving pattern analyzer analyzing a moving pattern of the mobile robot based on a type, a moving method, and a moving speed of the mobile robot;
a sight controller calculating a vibration compensation value based on the analyzed moving pattern of the mobile robot for compensating for the vibration of the camera; and
a sight adjustor adjusting a sight direction of the camera according to the vibration compensation value calculated by the sight controller.

2. The sight stabilization apparatus of claim 1, wherein the sight adjustor comprises a camera angle adjustment unit controlling an angle and a position of the camera according to the vibration compensation value calculated by the sight controller.

3. The sight stabilization apparatus of claim 1, wherein the sight adjustor comprises a vibration reduction unit comprising a passive type damper and a spring for reducing the vibration of the camera.

4. The sight stabilization apparatus of claim 1, wherein the sight adjustor comprises a vibration reduction unit comprising an active type damper and a spring that are controlled according to the vibration compensation value calculated by the sight controller for reducing the vibration of the camera.

5. The sight stabilization apparatus of claim 1, wherein the camera vibration detector comprises a vibration detection sensor attached to the camera for detecting vibration of the camera when the mobile robot moves.

6. The sight stabilization apparatus of claim 1, wherein the moving pattern analyzer analyzes the moving pattern of the mobile robot based on the moving method and the moving speed of the mobile robot when the mobile robot is a multiple-legged robot.

7. The sight stabilization apparatus of claim 1, wherein the moving pattern analyzer analyzes the moving pattern of the mobile robot based on the moving speed of the mobile robot when the mobile robot is a rough road moving robot.

8. The sight stabilization apparatus of claim 1, wherein when the mobile robot is an inverted pendulum type robot, the moving pattern analyzer analyzes the moving pattern of the mobile robot based on information about robot position controlling performed for preventing the mobile robot from falling down.

9. A sight stabilization apparatus for a mobile robot with a camera, the sight stabilization apparatus comprising:
an image analyzer analyzing images captured by the camera for detecting a variation of a sight direction of the camera;
a moving pattern analyzer analyzing a moving pattern of the mobile robot based on a type, a moving method, and a moving speed of the mobile robot;
a sight controller calculating a vibration compensation value based on the analyzed moving pattern of the mobile robot for compensating for the variation of the sight direction of the camera; and
a sight adjustor adjusting the sight direction of the camera according to the vibration compensation value calculated by the sight controller.

10. The sight stabilization apparatus of claim 9, wherein the sight adjustor comprises a camera angle adjustment unit controlling an angle and a position of the camera according to the vibration compensation value calculated by the sight controller.

11. The sight stabilization apparatus of claim 9, wherein the sight adjustor comprises a vibration reduction unit comprising a passive type damper and a spring for reducing the vibration of the camera.

12. The sight stabilization apparatus of claim 9, wherein the sight adjustor comprises a vibration reduction unit comprising an active type damper and a spring that are controlled according to the vibration compensation value calculated by the sight controller for reducing the vibration of the camera.

13. The sight stabilization apparatus of claim 9, wherein the moving pattern analyzer analyzes the moving pattern of the mobile robot based on the moving method and the moving speed of the mobile robot when the mobile robot is a multiple-legged robot.

14. The sight stabilization apparatus of claim 9, wherein the moving pattern analyzer analyzes the moving pattern of the mobile robot based on the moving speed of the mobile robot when the mobile robot is a rough road moving robot.

15. The sight stabilization apparatus of claim 9, wherein when the mobile robot is an inverted pendulum type robot, the moving pattern analyzer analyzes the moving pattern of the mobile robot based on information about robot position controlling performed for preventing the mobile robot from falling down.

16. A mobile robot with a camera, comprising:
a camera vibration detector detecting vibration of the camera when the mobile robot moves;
a moving pattern analyzer analyzing a moving pattern of the mobile robot based on a type, a moving method, and a moving speed of the mobile robot;
a sight controller calculating a vibration compensation value based on the analyzed moving pattern of the mobile robot for compensating for the vibration of the camera; and
a sight adjustor adjusting a sight direction of the camera according to the vibration compensation value calculated by the sight controller.

17. A mobile robot with a camera, comprising:
an image analyzer analyzing images captured by the camera for detecting a variation of a sight direction of the camera;
a moving pattern analyzer analyzing a moving pattern of the mobile robot based on a type, a moving method, and a moving speed of the mobile robot;
a sight controller calculating a vibration compensation value based on the analyzed moving pattern of the mobile robot for compensating for the variation of the sight direction of the camera; and
a sight adjustor adjusting the sight direction of the camera according to the vibration compensation value calculated by the sight controller.
